(19) United States
(12) Patent Application Publication
(10) Pub. No.: US 2008/0011029 A1
(43) Pub. Date: Jan. 17, 2008

(54) LOCK

(76) Inventor: Rick-Teyu Chen, Pasadena, CA (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/456,744

(22) Filed: Jul. 11, 2006

(51) Int. Cl. E05B 59/00; E05B 63/14

(52) U.S. Cl. 70/107

(57) ABSTRACT

A lock includes a case, an actuating device for retracting a latch bolt, and a first and second pivotal assembly selectively coupled to a mounting wall of the case. The first pivotal assembly includes a first pivotal seat for coupling with a rotational outer handle and a second pivotal seat for coupling with an inner handle. The second pivotal assembly includes a third pivotal seat for coupling with an inner handle. One of the first pivotal assembly and the second pivotal assembly is selected for use with one of the rotational outer handle and a thumb-piece type outer handle. A rotational pressing member is selectively and rotatably mounted to the mounting wall when the lock is used with the thumb-piece type outer handle. The rotational pressing member is actuated to turn the actuating device for retracting the latch bolt when the thumb-piece type outer handle is pressed.

### BACKGROUND OF THE INVENTION

1. Field of the Invention

The present invention relates to a lock. More particularly, the present invention relates to a lock for selective use with a rotational outer handle or a thumb-piece type outer handle.

2. Description of Related Art

Taiwan Patent Publication No. M281045 discloses a general-purpose door lock comprising a case, a bolt-driving mechanism, a bolt assembly, a pivotal seat, an actuating rod, and an outer handle control device. The case receives all elements of the door lock. The bolt-driving mechanism controls movement of an auxiliary bolt. The bolt assembly is mounted in an intermediate section of the door lock and includes a latch bolt extending through a side of the case. The pivotal seat includes a through-hole through which an outer handle is extended. The pivotal seat includes a push member and a catch. An end of the actuating rod is engaged with the bolt assembly. The push member presses against the actuating rod. The outer handle control device includes a locking member and an unlocking member connected to the locking member. When the locking member is pressed, an end of the locking member engages with the catch of the pivotal seat, and the unlocking member is moved to an extended position. The locking member returns to its original position allowing pivotal movement of the pivotal seat when the unlocking member in the extended position is pressed.

In a case that the locking member is not pressed, the pivotal seat is turned when the outer handle is turned, causing the push member to press against and turn the actuating rod. Hence, the actuating rod presses against the latch bolt assembly and thus retracts the latch bolt into the case, allowing opening of the door. When the locking member is pressed, an end of the locking member is engaged with the catch of the pivotal seat and thus prevents the pivotal seat from turning.

However, such a door lock can only be used with a rotational outer handle. Namely, this door lock cannot be used an outer handle of another type, such as a thumb-piece type outer handle.

### OBJECTS OF THE INVENTION

An object of the present invention is to provide a lock that allows selective use with a rotational outer handle or a thumb-piece type outer handle.

Another object of the present invention is to provide a lock with enhanced anti-theft effect by disabling the outer handle.

### SUMMARY OF THE INVENTION

A lock in accordance with the present invention

a case comprising a faceplate and a mounting wall;

a bolt-driving assembly including an auxiliary bolt and a driving member for moving the auxiliary bolt between an extended position outside the case and a retracted position inside the case;

a bolt assembly comprising a rod, a latch bolt, a fixed member fixed to the mounting wall, an elastic element mounted between the latch bolt and the fixed member, and an engaging member, the latch bolt being fixed to an end of the rod and extendible through the faceplate, the rod being movably extended through the fixed member, the engaging member being mounted to another other end of the rod;

an actuating device comprising a main body having an end rotatably mounted to the mounting wall, a catch being formed on another end of the main body and engaged with the engaging member of the bolt assembly;

a first pivotal assembly selectively coupled to the mounting wall, the first pivotal assembly comprising a first pivotal seat for coupling with a rotational outer handle and a second pivotal seat for coupling with an inner handle, the first pivotal seat and the second pivotal seat being pivotably mounted to the mounting wall;

a second pivotal assembly selectively coupled to the mounting wall, the second pivotal assembly comprising a third pivotal seat for coupling with an inner handle, the second pivotal assembly including a third pivotal seat pivotably mounted to the mounting wall;

one of the first pivotal assembly and the second pivotal assembly being selected for use with one of the rotational outer handle and a thumb-piece type outer handle; and

a rotational pressing member selectively and rotatably mounted to the mounting wall and coaxial with the main body when the lock is used with the thumb-piece type outer handle, the rotational pressing member being actuated to turn the actuating device for retracting the latch bolt when the thumb-piece type outer handle is pressed;

the first pivotal seat being turned to actuate the actuating device for retracting the latch bolt when the rotational outer handle is turned.

By such an arrangement, a user may replace some of the elements to modify the lock for the purposes of selective use with a thumb-piece type outer handle or a rotational outer handle. The cost for converting a lock for use with a thumb-piece type outer handle into a lock for use with a rotational outer handle is largely reduced.

Preferably, the lock further comprises an outer handle control device including a locking member extendible through the faceplate, the locking member having a stop, an unlocking member extendible through the faceplate, and a follower mounted between the locking member and the unlocking member such that movement of one of the locking member and the unlocking member in a direction causes movement of the other of the locking member and the unlocking member in a reverse direction. When the locking member is pressed, the unlocking member is in an extended position, and the stop of the locking member prevents the latch bolt from being retraced when outer handle is turned.

When the unlocking member in the extended position is pushed, the locking member is moved to a position allowing retraction of the latch bolt when the outer handle is pushed.

Preferably, the first pivotal seat includes an engaging notch that is releasably engaged with the stop of the outer handle control device when the locking member is pressed.

Preferably, the stop of the outer handle control device abuts against the rotational push member for preventing the rotational push member from rotating when the locking member is pressed.

Preferably, the case includes a slot. The thumb-piece type outer handle includes a pressing member extending through the slot. The pressing member presses the rotational push member to turn when the thumb-piece type outer handle is pressed.

Preferably, the first pivotal seat includes a push member. The push member of the first pivotal seat presses against the catch and thus turns the main body of the actuating device when the rotational outer handle is turned.

Preferably, the second pivotal seat includes a push member. The push member of the second pivotal seat presses against the catch and thus turns the main body of the actuating device when the inner handle is turned.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of an example of a lock in accordance with the present invention;

FIG. 2 is a sectional view of the lock of FIG. 1, wherein a locking member is not pressed;

FIG. 3 is a view similar to FIG. 2, wherein the locking member is pressed;

FIG. 4 is an exploded perspective view of another example of the lock in accordance with the present invention;

FIG. 5 is a sectional view of the lock in FIG. 4; wherein the locking member is not pressed; and

FIG. 6 is a view similar to FIG. 5, wherein the locking member is pressed.

### DETAILED DESCRIPTION OF THE PREFERRED EMBODIMENTS

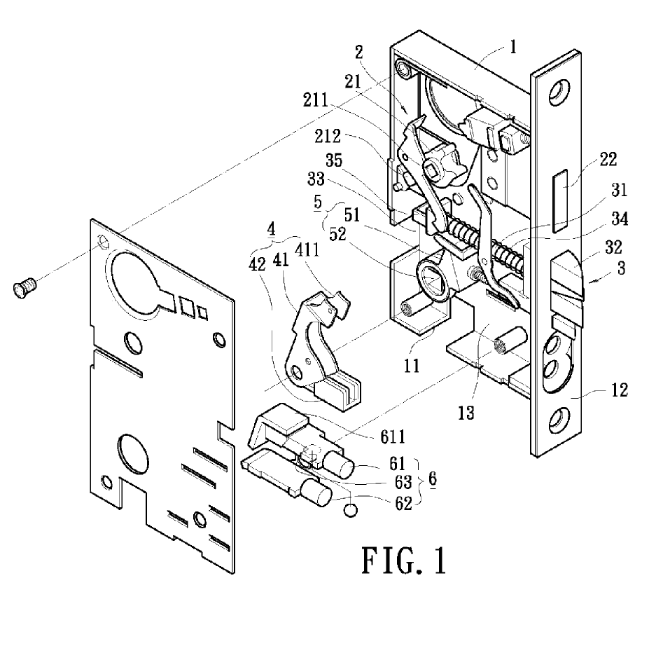

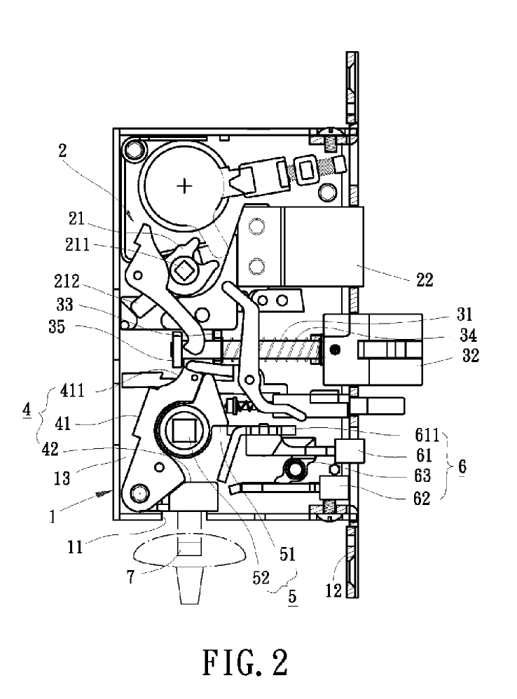

FIGS. 1 and 2 illustrate an example of a lock in accordance with the present invention for use with a thumb-piece type outer handle. The lock comprises a case 1, a bolt-driving mechanism 2, a bolt assembly 3, an actuating device 4, a pivotal seat 5, and an outer handle control device 6. The case 1 receives all of the elements and includes a slot 11 in an end face of the case 1, a faceplate 12 adjacent to the end face having the slot 11, and a mounting wall 13 adjacent to the faceplate 12.

Still referring to FIGS. 1 and 2, the bolt-driving mechanism 2 includes a driving member 21 and an auxiliary bolt. The driving member 21 is rotatably mounted to the mounting wall 13 and includes an insertion hole 211 and a push rod 212. A turn-piece (not shown) or the like is coupled with the insertion hole 211 and may be turned for turning the driving member 21. The auxiliary bolt 22 is extendible through the faceplate 12 and connected to the driving member 21. Thus, when the driving member 21 is turned, the auxiliary bolt 22 is moved to an extended position outside the case 1 or a retracted position inside the case 1.

Still referring to FIGS. 1 and 2, the bolt assembly 3 includes a rod 31, a latch bolt 32, a fixed member 33, an elastic element 34, and an engaging member 35. The latch bolt 32 is fixed to an end of the rod 31 and extendible through the faceplate 12. The rod 31 is movably extended through the fixed member 33 that is fixed to the mounting wall 13. The elastic element 34 is mounted between the latch bolt 32 and the fixed member 33 and is preferably a spring mounted around the rod 31. The engaging member 35 is mounted to the other end of the rod 31.

Still referring to FIGS. 1 and 2, the actuating device 4 in this example includes a main body 41 and a rotational pressing member 42. An end of the main body 41 is rotatably mounted to the mounting wall 13. A catch 411 is formed on the other end of the main body 41 and engaged with the engaging member 35 of the bolt assembly 3. The rotational pressing member 42 is coaxial with the main body 41 and rotatably mounted to the mounting wall 13. Furthermore, the rotational pressing member 42 is located in the case 1 in a position adjacent to the slot 11.

Still referring to FIGS. 1 and 2, the pivotal seat 5 is pivotably mounted in the case 1 and includes a push member 51 and a through-hole 52. The push member 51 is movable to press against the main body 41. An inner handle (not shown) is coupled with the through-hole 52 and thus secured to the pivotal seat 5.

The outer handle control device 6 includes a locking member 61, an unlocking member 62, and a follower 63. An end of the locking member 61 is extended through the faceplate 12, and a stop 611 is formed on the other end of the locking member 61. An end of the unlocking member 62 is extended through the faceplate 12. The follower portion 63 is rotatably mounted to the mounting wall 13. Two ends of the follower portion 63 are rotatably mounted to an intermediate portion of the locking member 61 and an intermediate portion of the unlocking member 62, respectively. Thus, the locking member 61 and the unlocking member 62 move one with respect to the other in reverse directions.

Still referring to FIGS. 1 and 2, when the thumb-piece type outer handle is operated, namely when a thumb-piece (not shown) is pressed, a pressing block 7 of the thumb-piece type outer handle moves upward and presses against the rotational push member 42. The rotational push member 42 moves upward and presses against the main body 41, causing rotational movement of the main body 41. The catch 411 on the main body 41 is thus moved, which, in turn, urges the engaging member 35 to move in a direction away from the faceplate 12, retracting the latch bolt 32 into the case 1 while compressing the elastic element 34, thereby allowing opening of the door.

When the thumb-piece is released, the external force applied to the pressing block 7 no longer exists. Hence, the pressing block 7 moves downward to its original position. The latch bolt 32 extends outward to the extended position under the action of the elastic element 34. Also, the engaging member 35, the main body 41, and the rotational push member 42 are returned to their original positions.

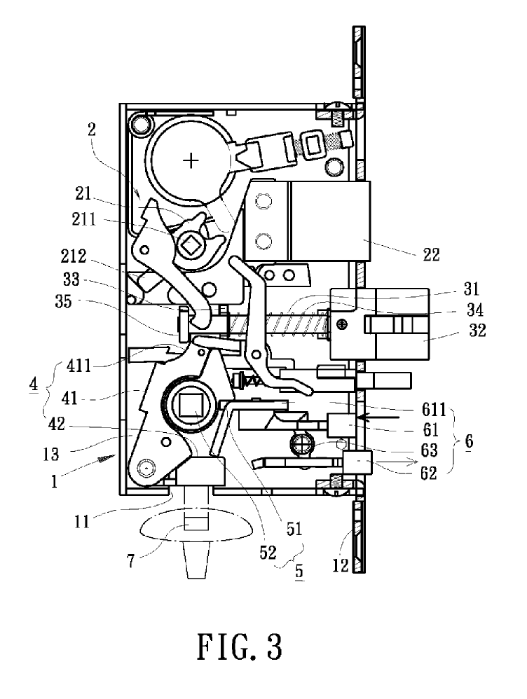

Referring to FIGS. 1 and 3, when the locking member 61 is pressed, the locking member 61 moves inward in a direction away from the faceplate 12, and the unlocking member 62 protrudes beyond the faceplate 12. In this case, the stop 611 of the locking member 61 abuts against an upper face of the rotational push member 42 and thus prevents the rotational push member 42 from rotating. Thus, when the thumb-piece is pressed, the pressing member 7 cannot drive the rotational push member 42 to turn, thereby disabling the outer handle.

Still referring to FIGS. 1 and 3, when the locking member 61 is in a pressed position in the case 1, the inner handle (not shown) can be turned to turn the pivotal seat 5. The push member 51 presses against the main body 41, which, in turn, retracts the latch bolt 32 into the case 1, thereby allowing opening of the door. Furthermore, when the unlocking member 62 is pressed, the follower 63 is moved, which, in turn, urges the locking member 61 and the stop 61 to move toward the faceplate 12. The stop 611 no longer stops the rotational push member 42, allowing normal operation of the thumb-piece type outer handle.

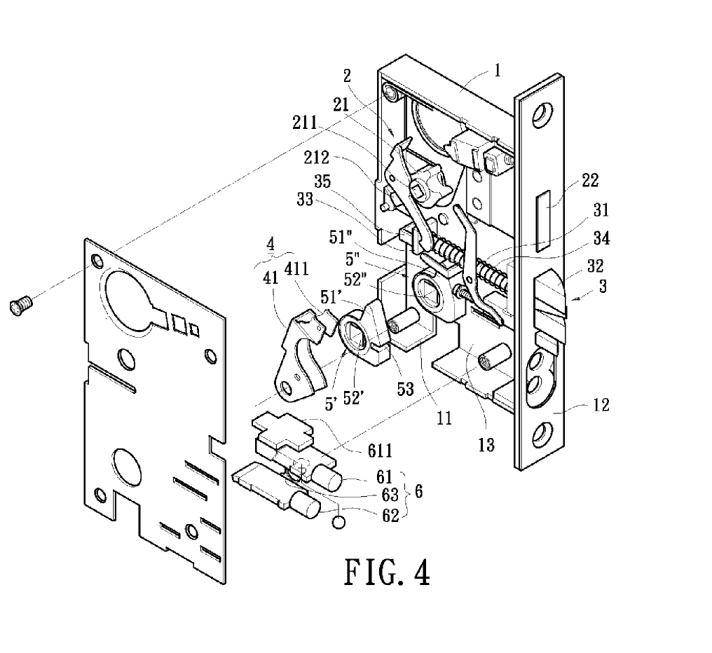

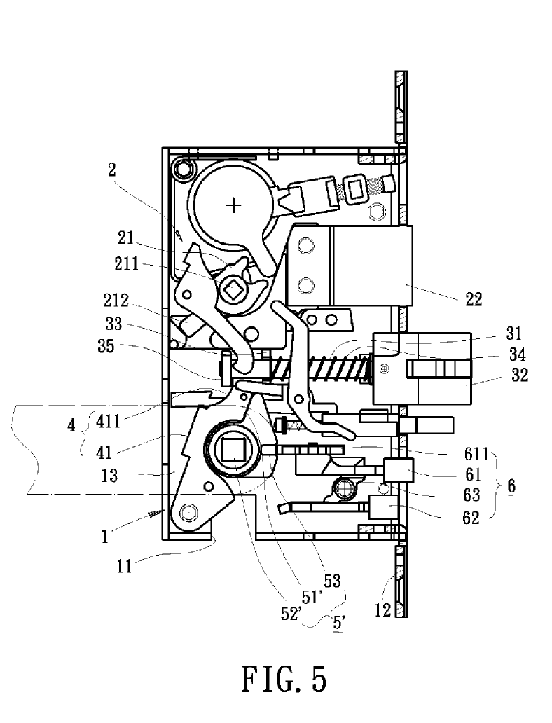

FIGS. 4 and 5 illustrate another example of the lock in accordance with the present invention for use with a rotational outer handle. In this example, the actuating device 4 includes a main body 41 having an end rotatably mounted to the mounting wall 13. A catch 411 is formed on the other end of the main body 41 and engaged with the engaging member 35 of the bolt assembly 3. Namely, the rotational pressing member 42 in the above example is omitted.

Further, the lock of this example includes a first pivotal seat 5′ and a second pivotal seat 5″. The first pivotal seat 5′ is pivotably mounted in the case 1 and includes a push member 51′ and a through-hole 52′. The push member 51′ is movable to press against the main body 41. A rotational outer handle (see the phantom lines in FIG. 5 is coupled with the through-hole 52′ and thus secured to the first pivotal seat 5′. The second pivotal seat 5′ is pivotably mounted in the case 1 and includes a push member 51″ and a through-hole 52″. The push member 51″ is movable to press against the main body 41. An inner handle (not shown) is coupled with the through-hole 52″ and thus secured to the second pivotal seat 5″.

The outer handle control device 6 in this example also includes a locking member 61, an unlocking member 62, and a follower 63, which are identical to those of the first embodiment except that the stop 611 on the locking member 61 may be inserted into and thus engaged in the engaging groove 53 of the first pivotal seat 53.

Still referring to FIGS. 4 and 5, when the rotational outer handle is turned, the push member 51′ of the first pivotal seat 5′ is moved to press against the catch 411, urging the engaging member 35 to move in a direction away from the faceplate 12, thereby retracting the latch bolt 32 into the case 1 while compressing the elastic element 34.

When the force applied to rotational outer handle is released, the latch bolt 32 extends outward to the extended position under the action of the elastic element 34. Also, the engaging member 35, the main body 41, and the push member 51′ of the first pivotal seat 5′ are returned to their original positions.

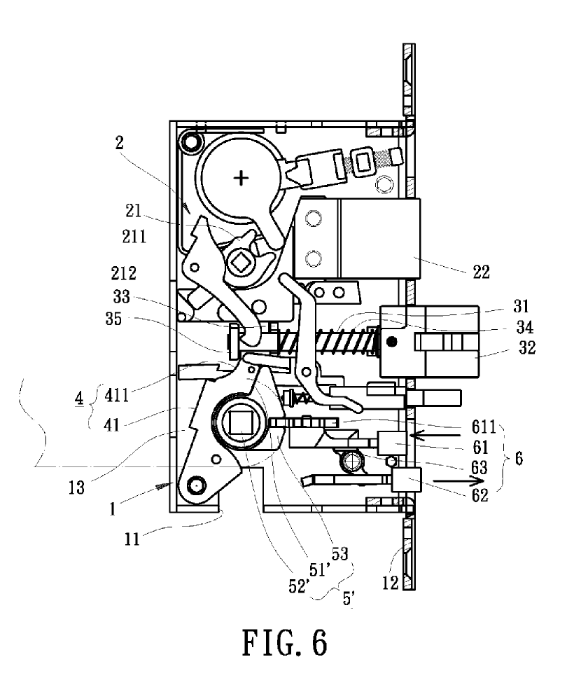

Referring to FIGS. 4 and 6, when the locking member 61 is pressed, the locking member 61 moves inward in a direction away from the faceplate 12, and the unlocking member 62 protrudes beyond the faceplate 12. In this case, the stop 611 of the locking member 61 is engaged in the engaging groove 53 of the first pivotal seat 5′. Thus, when the rotational outer handle is turned, the latch bolt 32 cannot be retracted, as the first pivotal seat 5′ cannot turn. Namely, the rotational outer handle is disabled.

Still referring to FIGS. 4 and 6, when the locking member 61 is in a pressed position in the case 1, the inner handle (not shown) can be turned to turn the second pivotal seat 5″. The push member 51″ presses against the catch 411, which, in turn, retracts the latch bolt 32 into the case 1, thereby allowing opening of the door. Furthermore, when the unlocking member 62 is pressed, the follower 63 is moved, which, in turn, urges the locking member 61 and the stop 61 to move toward the faceplate 12. The stop 611 is no longer engaged with the engaging groove 53 of the first pivotal seat 5′, allowing normal operation of the rotational outer handle.

By such an arrangement, a user may replace some of the elements to modify the lock for the purposes of selective use with a thumb-piece type outer handle or a rotational outer handle. More specifically, when use with a thumb-piece type outer handle, a pivotal seat 5, an actuating rod 4 with a rotational pressing member 42, and an outer handle control device 61 with a stop 611 for stopping the rotational pressing member 42 are used (see FIG. 1), and when use with a rotational outer handle, two separate pivotal seats 5′ and 5″, an actuating rod 4 without a rotational pressing member 42, and an outer handle control device 61 with a stop 611 for stopping rotational movement of one of the pivotal seats (i.e., the first pivotal seat 5′) are used (see FIG. 4). The cost for converting a lock for use with a thumb-piece type outer handle into a lock for use with a rotational outer handle is largely reduced. The number of elements required for such a conversion can be reduced when locking of the outer handle is not required.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A lock comprising:
a case comprising a faceplate and a mounting wall;
a bolt-driving assembly including an auxiliary bolt and a driving member for moving the auxiliary bolt between an extended position outside the case and a retracted position inside the case;
a bolt assembly comprising a rod, a latch bolt, a fixed member fixed to the mounting wall, an elastic element mounted between the latch bolt and the fixed member, and an engaging member, the latch bolt being fixed to an end of the rod and extendible through the faceplate, the rod being movably extended through the fixed member, the engaging member being mounted to another other end of the rod;
an actuating device comprising a main body having an end rotatably mounted to the mounting wall, a catch being formed on another end of the main body and engaged with the engaging member of the bolt assembly;
a first pivotal assembly selectively coupled to the mounting wall, the first pivotal assembly comprising a first pivotal seat for coupling with a rotational outer handle and a second pivotal seat for coupling with an inner handle, the first pivotal seat and the second pivotal seat being pivotably mounted to the mounting wall;
a second pivotal assembly selectively coupled to the mounting wall, the second pivotal assembly comprising a third pivotal seat for coupling with an inner handle, the second pivotal assembly including a third pivotal seat pivotably mounted to the mounting wall;
one of the first pivotal assembly and the second pivotal assembly being selected for use with one of the rotational outer handle and a thumb-piece type outer handle; and
a rotational pressing member selectively and rotatably mounted to the mounting wall and coaxial with the main body when the lock is used with the thumb-piece type outer handle, the rotational pressing member being actuated to turn the actuating device for retracting the latch bolt when the thumb-piece type outer handle is pressed;
the first pivotal seat being turned to actuate the actuating device for retracting the latch bolt when the rotational outer handle is turned.

2. The lock as claimed in claim 1 further comprising an outer handle control device including:
a locking member extendible through the faceplate, the locking member including a stop;
an unlocking member extendible through the faceplate; and
a follower mounted between the locking member and the unlocking member such that movement of one of the locking member and the unlocking member in a direction causes movement of the other of the locking member and the unlocking member in a reverse direction;
wherein when the locking member is pressed, the unlocking member is in an extended position, and the stop of the locking member prevents the latch bolt from being retraced when outer handle is turned.

3. The lock as claimed in claim 2 wherein when the unlocking member in the extended position is pushed, the locking member is moved to a position allowing retraction of the latch bolt when the outer handle is pushed.

4. The lock as claimed in claim 3 wherein the first pivotal seat including an engaging notch that is releasably engaged with the stop of the outer handle control device when the locking member is pressed.

5. The lock as claimed in claim 3 wherein the stop of the outer handle control device abuts against the rotational push member for preventing the rotational push member from rotating when the locking member is pressed.

6. The lock as claimed in claim 1 wherein the case further includes a slot, the thumb-piece type outer handle including a pressing member extending through the slot, the pressing member pressing the rotational push member to turn when the thumb-piece type outer handle is pressed.

7. The lock as claimed in claim 1 wherein the first pivotal seat includes a push member and wherein the push member of the first pivotal seat presses against the catch and thus turns the main body of the actuating device when the rotational outer handle is turned.

8. The lock as claimed in claim 1 wherein the second pivotal seat includes a push member and wherein the push member of the second pivotal seat presses against the catch and thus turns the main body of the actuating device when the inner handle is turned.
